(19) United States
(12) Patent Application Publication
(10) Pub. No.: US 2010/0236245 A1
(43) Pub. Date: Sep. 23, 2010

(54) Gas Turbine Combustion System

(76) Inventors: Clifford E. Johnson, Orlando, FL (US); Joachim Lepers, Rosenheim (DE); Samer P. Wasif, Oviedo, FL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/407,133

(22) Filed: Mar. 19, 2009

(51) Int. Cl. F02C 7/24

(52) U.S. Cl. 60/725

(57) ABSTRACT

A gas turbine combustion system has a combustion system wall delimiting a flow path for hot and pressurized combustion gas and at least one resonator with a resonator volume. The resonator volume is delimited by resonator walls, where one of the resonator walls is located adjacent to or is formed by the combustion system wall. The resonator has at least one cooling fluid supply opening which is open towards a cooling fluid source. It further has a neck opening which is open towards the flow path and which is implemented in the form of a neck slot.

### FIELD OF THE INVENTION

The present invention relates to a gas turbine combustion system, in particular to a gas turbine combustion system comprising a resonator. In addition, the invention relates to a gas turbine.

### BACKGROUND OF THE INVENTION

Gas turbine combustion systems using lean premix combustion technology show a tendency towards self-excited acoustic oscillations. The reason for this phenomenon is the interaction of the heat release in the flame with pressure levels in the combustion system. At certain conditions pressure oscillations can be generated which can lead to acoustic noise in the combustor. At certain frequencies, amplification of such pressure oscillations may occur leading to very high acoustic pressure levels in the combustor necessciating engine shut down for avoiding damage to the combustor structure.

Resonators are a common means for providing additional damping and detuning of pressure oscillations at the frequencies which are prone to be excited in gas turbine combustion systems. Particularly resonators avoiding high frequency dynamics (HFD) are often used in modern gas turbine combustion chambers. A combustion system comprising resonators is, for example, described in U.S. Pat. No. 6,530,221 B1. The resonators described therein comprise an array of cooling air supply holes and an array of neck holes connecting the resonator volume to the combustion space of the combustion system where acoustic oscillations are to be damped. In order to prevent hot combustion gas from entering the neck holes these holes are purged with cooling air. However, resonators requiring cooling air may inhibit thermal barrier coating on the combustor liner in the region where resonators are installed. Therefore, they may reduce the life cycle of a combustor liner due to local overheating if not sufficient cooling air or thermal barrier coating of the combustor can be provided. In addition the array of neck holes requires high effort during the production process when it is masked for subsequent thermal barrier coating. With the small diameter of the holes used, masking must be done carefully since the frequency at which resonators are most effective is sensitive to the effective hole length influenced by the thermal barrier coating thickness. If the effort for masking within set tolerance limits is too high, it might even be inhibitive for coating. In this case, overheating of the combustor liner may occur since the pressure of the cooling air provided is generally high enough for purging the neck holes whilst the mass flow might not be sufficient for providing sufficient cooling of the structure.

### SUMMARY OF THE INVENTION

It is therefore an objective of the present invention to provide an advantageous gas turbine combustion system comprising a resonator which allows for purging a neck opening with cooling air. It is a further objective of the present invention to provide an advantages gas turbine.

The first objective is solved by a gas turbine combustion system and the second objective is solved by a gas turbine as claimed in the independent claims. The depending claims contain further developments of the invention.

An inventive gas turbine combustion system comprises a combustion system wall delimiting a flow path for hot and pressurized combustion gas and at least one resonator with a resonator volume delimited by resonators walls. One of the resonator walls is located adjacent to, or is formed by, a wall of the combustion system, called combustion system wall henceforth. The resonator comprises a neck opening being open towards the flow path and at least one cooling fluid supply opening being open towards a cooling fluid source. The neck opening is implemented in the form of a neck slot.

According to the invention, the array of resonator neck holes used in the state of the art combustion systems is replaced by a slot. The effective area of the neck slot is chosen depending on the frequency to be damped, the resonator volume and the resonator neck length which is given by the thickness of the combustion system wall including the acoustically relevant thermal barrier coating thickness plus, if applicable, the resonator wall being located adjacent to the combustion system wall, and the acoustic radiation effects at the inlet and the outlet of the neck. When coating the surrounding surface of the combustion system wall the neck slot can easily be masked as compared to an array of relatively small neck holes. Hence, the combustion system wall can more easily be protected by thermal barrier coatings in locations where resonators are provided than in the state of the art. Such areas which could not be covered by thermal barrier coating due to masking can be effectively cooled by the cooling fluid used for purging the slot since regions not covered by thermal barrier coating due to a masking lie adjacent to the slot.

The advantages achievable by the invention are most effectively realized if there is only one single neck slot for each resonator, i. e. the neck slot of a resonator is the only opening of the respective resonator towards the flow path of the hot combustion gas.

In addition to the neck opening, the at least one cooling fluid supply opening can be implemented as a slot, called supply slot in the following, too. Like the neck slot being the only opening of the resonator towards the flow path the supply slot may be the only opening of the resonator towards the cooling fluid supply.

Independent of the implementation of the at least one cooling fluid supply opening said at least one opening is advantageously present in a resonator wall which is located in an opposing relationship to the resonator wall comprising the neck slot. In particular, the at least one cooling fluid supply opening may be aligned with the neck slot, for example by providing a single supply slot as a cooling fluid supply opening which is aligned with the neck slot, or by providing a number of cooling fluid supply holes as cooling fluid supply openings which are arranged along a line which is aligned with the neck slot. Hence, according to the mentioned development of the invention the array of cooling fluid supply holes used in the state of the art is replaced by a small number of holes, or a single slot, effectively providing purge air to the neck slot such that hot gas ingestion is avoided.

According to a further development of the inventive gas turbine combustion system the resonator comprises at least one circumferential wall, and the neck slot is located close to and extending along the circumferential wall. The same may be true for a supply slot or a line of supply holes. Note that the resonator comprises one circumferential wall if it has a circular geometry, two circumferential walls if the resonator has an annular geometry, and three or more circumferential walls if the resonator has a polygonal geometry. According to the geometry, the slot or line may be a linear slot, a broken slot or line, or an arcuate slot or line.

If the resonator comprises at least two circumferential walls, e.g. four circumferential walls so that it has a tetragonal shape, the neck slot may be located close to and extending along a first one of the circumferential walls and the at least one cooling fluid supply opening may be located close to and extending along a second one of the circumferential walls. The second one may, in particular, be located in an opposing relationship to the first circumferential wall. In this configuration, the cooling fluid needs to flow along the resonator wall located at the hot gas path side of the resonator to the neck slot so that this wall is cooled by the cooling fluid before the neck slot is purged.

In the inventive combustion system the combustion system wall may particularly comprise a hot side which is directed towards the flow path and which is provided with a thermal barrier coating. By providing a thermal barrier coating overheating of the combustion system wall can be avoided, in particular if the cooling air in the resonator volume flows along the combustion system wall before purging the neck slot.

An inventive gas turbine comprises an inventive combustion system. In such a gas turbine, exciting acoustic oscillations can be suppressed without reducing the lifetime of the combustion system wall at locations where resonators are present.

### BRIEF DESCRIPTION OF THE DRAWINGS

Further features, properties and advantages of the present invention will be come clear from the following description of embodiments in conjunction with the accompanying drawings.

FIG. 1 shows a gas turbine in a highly schematic sectional view.

FIG. 2 schematically shows a section of a first embodiment of the inventive gas turbine combustion system in a perspective view.

FIG. 3 shows the embodiment of FIG. 1 in sectional view.

FIG. 4 shows a modification of the first embodiment.

FIG. 5 schematically shows a section of a second embodiment of the inventive gas turbine combustion system in a perspective view.

FIG. 6 schematically shows a section of a modification of the second embodiment in a perspective view.

FIG. 7 schematically shows a section of a third embodiment of the inventive gas turbine combustion system in a perspective view.

### DETAILED DESCRIPTION OF THE INVENTION

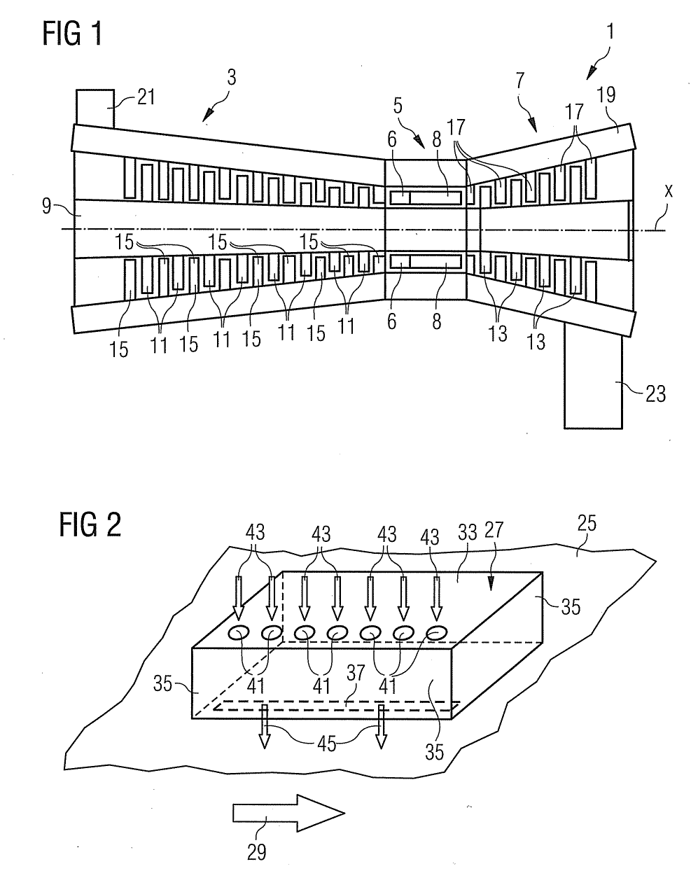

FIG. 1 shows, in a highly schematic view, a gas turbine engine 1 comprising a compressor section 3, a combustor section 5 and a turbine section 7. A rotor 9 extends through all sections and carries, in the compressor section 3, rings of compressor blades 11 and, in the turbine section 7, rings of turbine blades 13. Between neighbouring rings of compressor blades 11 and between neighbouring rings of turbine blades 13, rings of compressor vanes 15 and turbine vanes 17, respectively, extend from a housing 19 of the gas turbine engine 1 radially inwards towards the rotor 9.

The combustor section 5 is arranged between the compressor section 3 and the turbine section 7. It comprises a combustion system with at least one combustion chamber 8 to which one or more burners 6 are connected. The at least one burner 6 receives a gaseous or liquid fuel from a fuel supply system. In addition, the at least one burner 6 is in fluidic communication with the compressor section 3 to receive compressed air. The combustion chamber 8 is in fluidic communication with the turbine section 7 to deliver hot and pressurized hot combustion gas resulting from a combustion of an fuel-air mixture in the combustion chamber 8 to the turbine blades 13.

In operation of the gas turbine engine 1 air is taken in through an air inlet 21 of the compressor section 3. The air is compressed and, at the same time, led towards the combustor section 5 by the rotating compressor blades 11. In the combustor section 5 the air is mixed with a gaseous or liquid fuel and the mixture is burnt in the at least one combustion chamber 8. The hot and pressurized combustion gas resulting from burning the fuel-air mixture is fed to the turbine section 7. On its way through the turbine section 7 the hot and pressurized gas transfers momentum to the turbine blades 13 while expanding and cooling, thereby imparting a rotational movement to the rotor 9 that drives the compressor and a consumer, e.g. a generator for producing electrical power or an industrial machine. The rings of turbine vanes 17 function as nozzles for guiding the hot and pressurized combustion gas so as to optimise the momentum transfer to the turbine blades 13. Finally, the expanded and cooled combustion gas leaves the turbine section 7 through an exhaust 23.

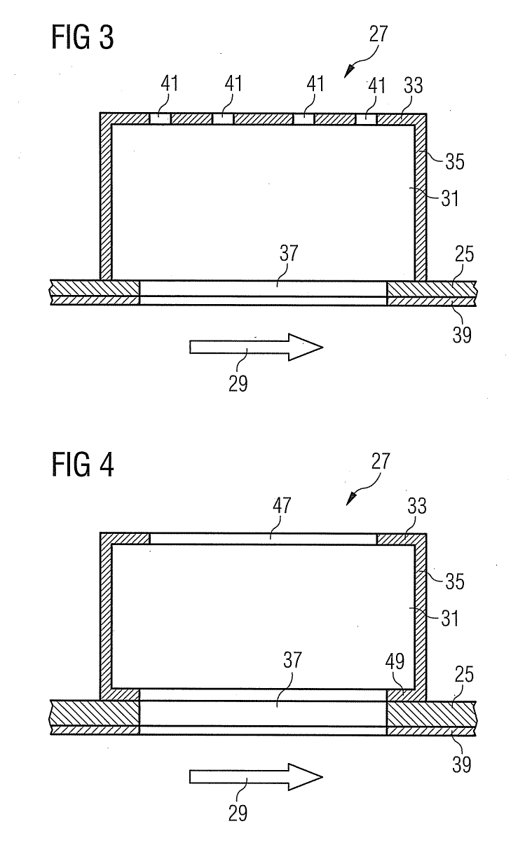

The first embodiment of the gas turbine combustion system according to the invention is depicted in FIGS. 2 and 3. While FIG. 2 schematically shows a three-dimensional view onto a section of a combustor wall or liner 25 which is equipped with a resonator, FIG. 3 shows a sectional view through the resonator 27 and the combustor wall or liner 25. Note that although it will be referred to “combustor wall” 25 from now on throughout the embodiments the term “combustor wall” shall also include the meaning of “combustor liner”.

In the present embodiment, the combustion system wall represented by the combustor wall 25 limits a flow path for hot and pressurized combustion gas. The flow of the hot and pressurized combustion gas is indicated by arrow 29. The resonator 27 is located adjacent to the combustor wall 25 so that the combustor wall 25 and an opposing resonator wall 33, together with circumferential resonator walls 35 extending between the combustor wall 25 and the opposing resonator wall 33, enclose a resonator volume 31.

A slot 37 is present in the combustor wall 25 connecting the combustor volume 31 to the flow path for the hot and pressurized combustion gas 29. The slot 37, which is located close to a circumferential wall 35 of the resonator 27, resembles a neck opening of the resonator being open towards the flow path for the hot and pressurized combustion gas. The neck length of the resonator neck provided by the slot 37 is given by the sum of the thicknesses of the combustor wall 25 and a thermal barrier coating 39 applied to the inside of the combustor wall, i. e. to the side of the combustor wall which faces the hot and pressurized combustion gas. By suitably choosing the length of the resonator neck together with the size of the resonator volume and the effective area of the neck slot the resonator can be tuned to a certain frequency to be damped.

In order to allow cooling air provided by the compressor to pass through the resonator volume 31 and the neck slot 37 into the flow path of the hot and pressurize combustion gas 27 for purging the neck slot 37 a number of feed holes 41 is present in a resonator wall 33 which is located in an opposing relationship to the combustor wall 25. The feed holes 41 are arranged along a line which is aligned with the neck slot 37 so that cooling air 43 entering the resonator volume 31 through the feed holes 41 can unhindered pass the volume 31 to purge the neck slot 37, as indicated by arrows 45. By allowing cooling air to effectively purge the neck slot 37 ingestion of hot and pressurized combustion gas into the resonator volume 31 can be effectively avoided.

Alternatively to a line of feed holes 41 a feed slot 47 could be provided in the resonator wall 33 as it is show in FIG. 4, which depicts a modification of the embodiment shown in FIGS. 2 and 3 in a sectional view. In addition to the modification given by the feed slot 47 as a cooling fluid supply opening instead of the feed holes 41 the resonator 27 also comprises a further resonator wall 49 which is arranged adjacent to the combustor wall 25 and, thus, in opposing relationship to the resonator wall 33 containing the feed slot 47. Hence, the neck slot 37 not only extends through the combustor wall 25 and the thermal barrier coating 39 but also through the further combustor wall 49, which increases the neck length provided by the neck slot 37.

A second embodiment of the inventive gas turbine combustion system is schematically shown in FIG. 5 in a perspective view. Those features of the second embodiment which do not differ from the first embodiment are denominated by the same reference numerals as in the first embodiment and will not be explained again.

The difference of the second embodiment with respect to the first embodiment lies in the direction the neck slot 137 and the line of feed holes 141 is oriented with respect to the flow direction of the hot and pressurized combustion gas 29. While the neck slot 37 and the line of feed holes 41 of the first embodiment are oriented in parallel to the flow direction of the hot and pressurized combustion gas the orientation of the neck slot 137 and the orientation of the line of feed holes 141 are perpendicular to the flow direction of the hot and pressurized combustion gas 29 in the present embodiment. Like in the first embodiment, the neck slot 137 and the feed holes 141 are aligned with each other and are located close to a circumferential resonator wall 35.

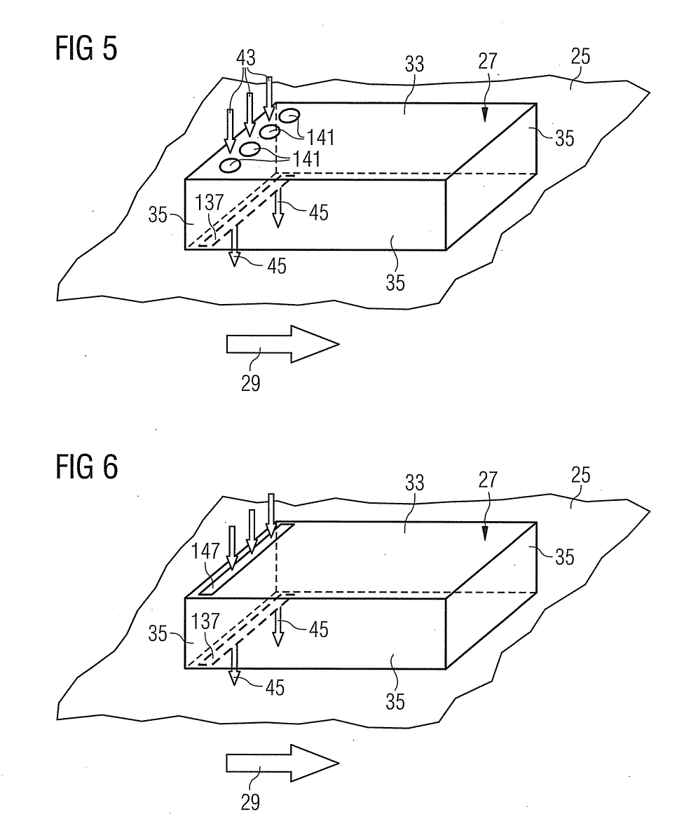

A modification of the second embodiment is shown in FIG. 6. The modification lies in that the line of feed openings 141 is replaced by a feed slot 147 which is aligned with the neck slot 137.

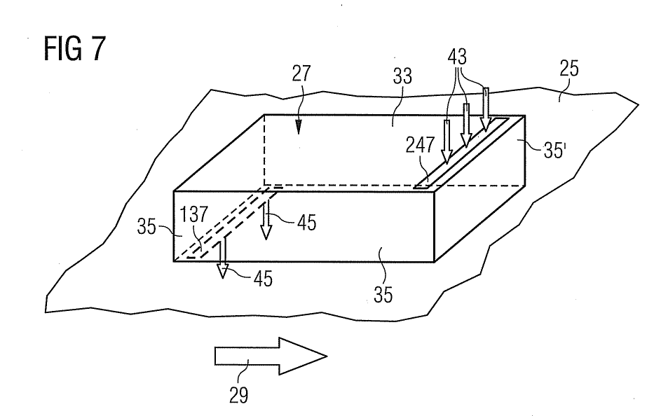

A third embodiment of the inventive gas turbine combustion system is shown in FIG. 7 which schematically shows a perspective view onto a section of a combustor wall 25 and a resonator 27. Features of the third embodiment which do not differ from features of the first and second embodiments are denominated with the same reference numerals as in the first and second embodiments and will not be explained again.

The third embodiment differs from the modification of the second embodiment shown in FIG. 6 in that a feed slot 247 is present which although sharing the same orientation with the neck slot 137 is not aligned with the neck slot 137. Instead, the feed slot 247 is located close to a second peripheral wall 35 which lies in opposing relationship to the peripheral wall 35 to which the neck slot 137 lies close to. This means that cooling air 43 which enters the resonator volume 31 through the feed slot 147 flows through the resonator volume along the combustor wall 25 to the neck slot 137. While flowing along the combustor wall 25 the cooling air can gather heat and hence cool the combustor wall 25 before purging the neck slot 137.

Note, that in all embodiments the resonator wall lying opposite to the resonator wall 33 containing the feed opening or feed slot, respectively, can be either formed by the combustor wall 25, as shown in FIG. 3, or by an inherent wall 49 of the resonator, as shown in FIG. 4.

The invention as has been described with respect to the embodiments improves a gas turbine combustion system including resonators in that a neck slot can more easily be masked prior to coating than an array of small neck holes. Hence, a coating can easily protect the liner material or wall material against overheating in the region where resonators are mounted. Cooling air can be directed to the neck slot leading to efficient purging of the slot with air and efficient cooling of the remaining liner material or wall material which could not be covered by coating due to masking.

1. A gas turbine combustion system, comprising:
a combustion system wall that delimits a flow path for a hot and pressurized combustion gas; and
a resonator comprising a neck opening being open towards the flow path and a cooling fluid supply opening being open towards a cooling fluid source,
wherein the neck opening is configured to be a neck slot.

2. The gas turbine combustion system as claimed in claim 1, wherein the resonator comprises resonator walls that delimit a resonator volume.

3. The gas turbine combustion system as claimed in claim 2, wherein one of the resonator walls is located adjacent to the combustion system wall or is formed by the combustion system wall.

4. The gas turbine combustion system as claimed in claim 1, wherein a single neck slot is an only opening of the resonator towards the flow path.

5. The gas turbine combustion system as claimed in claim 1, wherein the cooling fluid supply opening is configured to be a supply slot.

6. The gas turbine combustion system as claimed in claim 5, wherein a single supply slot is an only opening of the resonator towards the cooling fluid supply.

7. The gas turbine combustion system as claimed in claim 1, wherein the cooling fluid supply opening is located in a resonator wall opposite to a resonator wall comprising the neck slot.

8. The gas turbine combustion system as claimed in claim 7, wherein the cooling fluid supply opening is aligned with the neck slot.

9. The gas turbine combustion system as claimed in claim 7, wherein the cooling fluid supply opening comprises a plurality of cooling fluid supply holes.

10. The gas turbine combustion system as claimed in claim 9, wherein the cooling fluid supply holes are arranged along a line that is aligned with the neck slot.

11. The gas turbine combustion system as claimed in claim 1, wherein the resonator comprises a circumferential wall and the neck slot is located close to and extending along the circumferential wall.

12. The gas turbine combustion system as claimed in claim 1, wherein the resonator comprises a first circumferential wall and a second circumferential wall.

13. The gas turbine combustion system as claimed in claim 12, wherein the neck slot is located close to and extending along the first circumferential wall and the cooling fluid supply opening is located close to and extending along the second circumferential wall.

14. The gas turbine combustion system as claimed in claim 13, wherein the second circumferential wall is located opposite to the first circumferential wall.

15. The gas turbine combustion system as claimed in claim 1, wherein the combustion system wall comprises a hot side that is directed towards the flow path and comprises a thermal barrier coating.

16. A gas turbine, comprising:
a combustion system comprising:
a combustion system wall that delimits a flow path for a hot and pressurized combustion gas; and
a resonator comprising a neck opening being open towards the flow path and a cooling fluid supply opening being open towards a cooling fluid source,
wherein the neck opening is configured to be a neck slot.
